(19) United States
(12) Patent Application Publication
(10) Pub. No.: US 2012/0185341 A1
(43) Pub. Date: Jul. 19, 2012

(54) METHOD FOR THE CREATION, THE SELECTION AND THE DISTRIBUTION OF DATA PACKAGES FOR REMOTE INTERACTIVE TERMINALS

(75) Inventor: Andrea Giacobazzi, Sassuolo (MO) (IT)

(73) Assignee: ADB MULTIMEDIA S.R.L., Fiorano Modenese (MO) (IT)

(21) Appl. No.: 13/498,687

(22) PCT Filed: Sep. 27, 2010
(86) PCT No.: PCT/IB10/02419

§ 371 Date: Mar. 28, 2012

(30) Foreign Application Priority Data
Sep. 29, 2009 (IT) BO2009A 000622

(51) Int. Cl. G06Q 30/02

(52) U.S. Cl. 705/14.72

(57) ABSTRACT

A method for creation, selection, distribution and selective publication of data on remote terminals includes cyclic and asynchronous execution of sequences of different operational steps including a local loop for creation of packages of exclusive contents for each remote terminal, making subsets of a database, and storing the packages in dedicated areas of a temporary memory. A local loop periodically updates the content packages, recognizing older items with respect to corresponding elements residing in the database. Each remote terminal has a remote loop for periodical updating of an image of the exclusive package resident on the local server, with access to the dedicated area of the temporary memory resident on the local server, and retrieval of the package content elements updated by the local updating loop. Each remote terminal has a continuous operating loop, adapted to make the contents available to multiple users, according to modes defined by user commands.

### BACKGROUND OF THE INVENTION

The present invention fits in the technical field concerning handling of databases and their publication, i.e. their distribution and making available at sites where they are used.

In particular, the invention relates to a process for organization, selection, distribution, and selective publication of data on remote interactive terminals acting as information points placed at locations accessible to users, which not only are passive users of the information point contents themselves, but also active parts in navigating within the contents.

### BRIEF DESCRIPTION OF THE PRIOR ART

It is known that a particularly effective way of conveying information such as advertising, or showing promotional activities or other information materials concerning a particular type of products or services, is to place one or more devices displaying such information at strategic points, which maximize the effect of distributing the same information to an audience interested in getting it. This form of communication is generally known as “digital signage” and is often expected to replace conventional billboards, with obvious advantages in terms of versatility and impact on potential consumers.

A first example of this type of information point is given by the displays more and more frequently present on buses or subway cars, which cyclically transmit a content package (images, videos, vocal messages) for advertising, news or information aim of the service on which the information point is located.

In such a device the display is generally controlled by a computer device that is periodically updated remotely, i.e. by a staff moving from an information point to another to perform updates on the spot. The package is usually the same for all the information points which are connected to the same service, and can only be watched and listened by the users without any possibility of intervention by them.

Another example of a known type of information point is the information display systems located at different points in railway stations, airports and other sites where the public should be informed and updated about the occurrence of continuously evolving events (betting halls, etc.). As for stations and airports, these events obviously include departures and arrivals of trains or airplanes, and unforeseen changes in schedules or location of the same.

These remote information points include in their most advanced form, a set of monitors, placed at strategic points, where the information is displayed and changed at a given frequency. The contents of the information points are generally comprised of textual information, and more rarely of pictures or movies, and they are stored, managed and updated on a local server. The latter shall forward the data to display, usually the same for all the information points, or divided into a few types of contents (for example, arrivals and departures), simultaneously at predetermined time intervals.

To this type of information points belong, in general, even the equipment designed to display advertisements or promotional campaigns, individually or in sequence, related to one or several products or services. In this case, the single information point consists of a monitor controlled by a computer, which may be of standard type (“general purpose’) or specifically dedicated to that task. The content shown on the monitors may vary from simple text to still images or motion video, with or without audio. Some digital signage networks are comparable to television channels in which, in order to attract more public attention, alternating with advertisements, both information and entertainment contents are also transmitted. The content packages for each remote information point, or set of information points, are created and updated on a local server. Transmission and installation in a single location may be performed by means of a storage medium (CD, DVD or solid state memory), or by means of direct transmission over the Internet. In the latter case, the operator, when there are updates available for the content package, will create a new package for an information point or set of information points and send it to them, which are connected and available online.

Also in the above systems for using the contents, the use of the same by users is essentially passive. Also the display mode of the packages is sequential, so the content is displayed in cyclic, always identical sequences.

The digital signage networks which can be updated via the Internet, also provide, for each connected information point, a broadband Internet connection always on. This requires a high bandwidth from the network, also taking into account the size of the multimedia packages to be transmitted.

### OBJECTS OF THE INVENTION

One object of the present invention is to propose a method for the creation, distribution and selective publication of data on remote terminals, which method enables a customized use of the content of each terminal for each user of the same.

Another object of the invention is to propose a method for the creation, distribution and selective publication of data on remote terminals, which method simplifies the functions and the effort of the operator managing the system, and therefore reduces handling costs of the same.

Another object of the invention is to propose a method for the creation, distribution and selective publication of data on remote terminals, which method can handle the distribution of high quality multimedia contents minimizing the use of resources on the data transmission lines.

### SUMMARY OF THE INVENTION

The above-mentioned objects are achieved, in accordance with the contents of the claims, by a method for the creation, distribution and selective publication of data on remote terminals, which method includes the cyclic and asynchronous execution of sequences of different operational steps, respectively corresponding to:

a local loop for creation of packages of exclusive contents for each of the remote terminals, making up as many subsets of said database, and storing the packages in corresponding dedicated areas of a temporary memory resident on the local server;

a local loop for periodically updating the content packages, designed to recognize, for each package, older items with respect to corresponding elements residing in a database, and to replace them with the latter;

for each remote terminal, a remote loop for periodical updating of a remote content package consisting of an image of the corresponding exclusive package resident on the local server, such updating loop including an access to the dedicated area of the temporary memory resident on the local server, and a retrieving action of the package content elements updated by the local updating loop;

for each remote terminal, a continuous operating loop, adapted to make the contents available to multiple users, on the display unit, according to modes defined by commands received by the same users via the input unit.

### BRIEF DESCRIPTION OF THE DRAWINGS

The features of the invention, as they will result in the claims, are highlighted in the following detailed description, with reference to the attached drawings, in which:

FIG. 1 is a general block diagram of a system for the creation, distribution and publication of data on remote terminals which carries out the method according to the invention;

FIG. 2 is a flowchart of a local loop for the creation of an exclusive local content package of the method according to the invention;

FIG. 3 is a flowchart of a local loop for updating an exclusive local content package of the same method;

FIG. 4 is a flowchart of a remote loop for updating an exclusive remote content package, resident on any remote terminal, running on the same terminal;

FIG. 5 is a flowchart of a remote loop for clearing an exclusive remote content package, resident on any remote terminal, running. on the same terminal.

### DETAILED DESCRIPTION OF PREFERRED EMBODIMENTS OF THE INVENTION

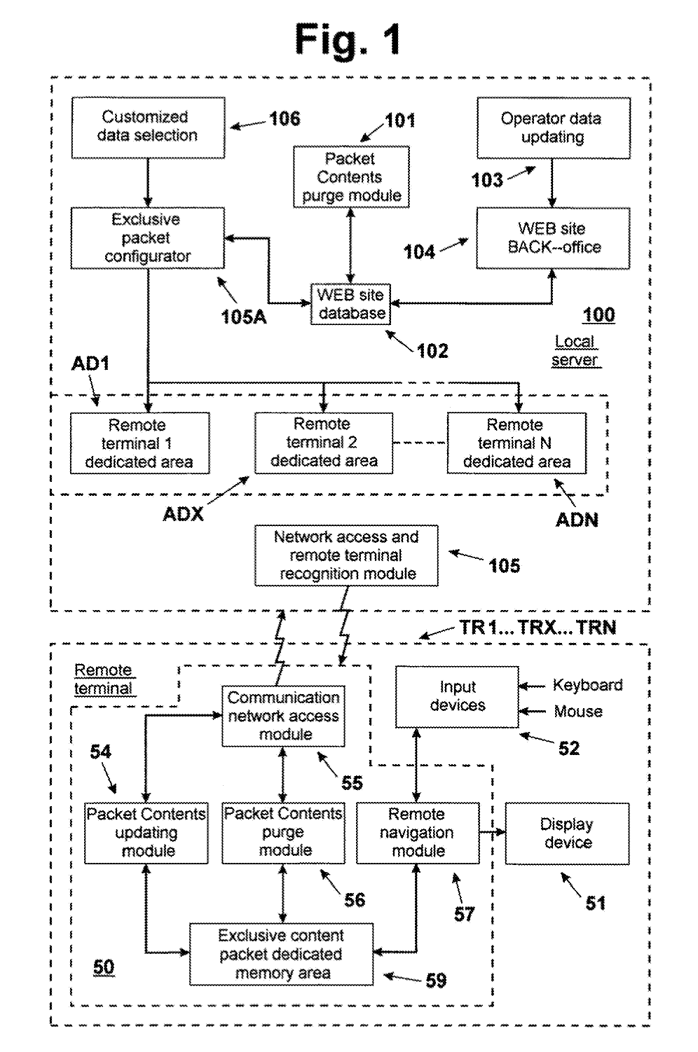

Referring to FIG. 1 and to an exemplary and not exclusive embodiment of the invention, described below is a general structure of a system of remote information points aimed at providing selected users with multimedia content packages, according to what will be described in more detail.

In this regard, numeral 100 indicates a local server adapted to manage, in accordance with fully known techniques and methods, a website 101 published online on the Internet. In order to better clarify the description of the invention and the issues that underlie it, and without any intention of limiting it, reference will be made later to a website providing business related contents, equipments and products in the ceramic industry. In particular, on the above mentioned site, multimedia contents relating to the production of different companies in the art are made available, which may be textual, graphic and photographic, video and audio presentations, etc. Basically, on the website 101, among other things, a multi-company catalog structure is present, which can be reviewed in accordance with pre-defined on-line full or selective accessing rules, by different categories of users. The contents are suitably encoded in digital format, according to the most appropriate standards for different types of products.

The multimedia contents accessible from the site are stored in a database 102, resident on that server 100, established and kept updated by one or more operators 103 using a website back-office module 104, also resident on the server 100.

The server 100 keeps active an access to a digital communication network, in particular the Internet, through a suitable access module 105, which implements in a known way all normal connection, recognition and identification functions of remote users, requested for operation of a structure of this type.

According to a characterizing aspect of the invention, on the local server 100 there is also provided a plurality of local temporary memory dedicated areas AD1, . . . ADX, . . . ADN, adapted to hold multimedia contents of the same type as those residing in the database 102, which function will become evident later in the description. In particular, each generic local area ADX is provided for receiving a related package of exclusive contents, consisting of a select subset of the database 102 of the on-line website 101.

An exclusive package configuration module 105, also resident on the local server 100, is designed to create and update each single element of the exclusive content packages in each local dedicated area ADX and the same package handling data structures.

The above remote information point system also includes a plurality of remote terminals TR1, . . . TRN, intended to make available as many packages of multimedia contents to a plurality of users. The terminals are located in suitable remote locations, in which they are accessible to the users to whom the information messages are directed. In particular, in the case of a system used in the ceramics field, the terminals may be located, e.g. at points of sale of the ceramic products, company showrooms or exhibition stalls. In this case the packages of multimedia contents mentioned above may include one or more catalogs of ceramic products, including text descriptions, pictures and video and audio presentations, e.g. of a selected part of the production of the company or of more companies, whose products are available in that particular store.

Each of the above mentioned remote terminals TR1, TRN, hereinafter generically identified as TRX, includes a central computer unit, comprising a processing unit 50 and also provided with a display unit 51, consisting of an LCD or plasma screen of an appropriate size, possibly with audio output, and one or more input and user interaction units 52, which may include an alphanumeric keyboard, a mouse, a “touch-screen” device, etc.

The remote terminal TRX also includes a software management system, which operates preferably on a standard operating system such as Windows XP®, Windows Vista® etc., and that includes a series of software operating modules capable of creating, updating and making available these multimedia contents.

In particular, as far as the structures for implementation of the invention are concerned, the functional configuration of each remote terminal TRX includes, in addition to the aforementioned display unit 51 and input unit 52, suitably connected to the terminal computer, a remote memory area 53, resident in the processing unit 50 of the terminal and intended to accommodate an exclusive package of multimedia contents to be made available to users.

In addition, each terminal has an updating module 54 of said exclusive package, which can be activated periodically and intended to keep the same package updated, according to a further particular aspect of the invention, and as will become evident below. Activation of the updating module 54 preferably occurs when the remote terminal TRX is started, but can possibly be scheduled in accordance with predefined periodical time intervals, or on command by a system or terminal administrator.

The updating module 54 interacts with the above-mentioned remote memory area 53 and with a module 55 for accessing a digital communication network. The latter preferably and naturally includes the Internet, but the use of other public or private communication networks, provided with sufficiently wide bandwidth, is possible without leaving the scope of the invention.

In the remote terminal TRX there is also provided a multimedia content package clearing module 56, designed to remove from the remote memory area 53 the contents became obsolete of the exclusive package of the same terminal. Also the clearing module 56 is intended to be activated periodically, when the remote terminal TRX is started or at predefined time intervals. It interacts with the remote memory area 53 and with said communication network access module 55.

Another module provided in the remote terminal TRX is the remote navigation module 57, designed to make the exclusive package contents provided for that terminal accessible to users. The navigation module 57 interacts with the input units 52 and the display unit 51, and with the remote memory area 53, in which the content package to be made available resides.

According to one aspect of the invention, the remote navigation module is advantageously structured as a navigable off-line website, essentially organized as a partial image of the aforementioned local website published on-line, with the same graphics and the same procedures to access the latter.

Substantially, the method according to the present invention comprises cyclic and asynchronous execution of different sequences of operational steps aimed at implementing many of the operational and management functions of the information point system. These sequences can be defined as a plurality of cycles, interacting with one another themselves and with the hardware and software structures of the local server and remote terminals, some of which run locally on the server 100 and others run remotely on these terminals TR1, . . . TRN.

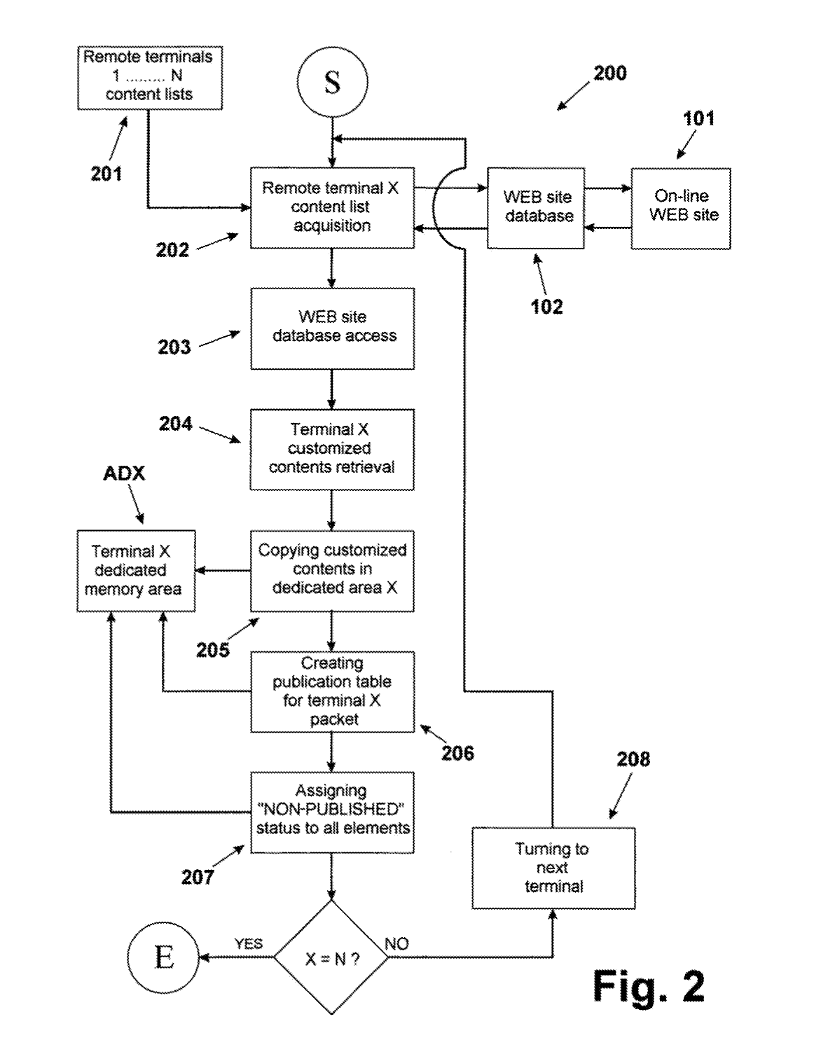

An exclusive content package creation local cycle 200, schematically illustrated in FIG. 2, is performed by the above configuration module 105 on the server 100. This creation cycle is periodically activated by an operator in a customized data selection session 106.

The local creation loop 200 of a content exclusive package for a generic remote terminal TRX, first includes a step 201, in which an operator defines a list of content for said terminal, and in which the configuration module 105 acquires 202 the same list upon input from the operator. This list of contents is a subset of the database 102 specifically selected for the particular remote terminal TRX depending on the companies and particular products for each company, which shall be made available in the information point located in a particular site.

A further operational step includes the web database 102 access 203, and the retrieval 204 from the same database of customized contents for the related terminal X, as defined in the list of contents.

Then there is a copy step 205, in which the above mentioned contents are copied to the corresponding local dedicated memory area ADX of server 100, to form the exclusive package for the terminal TRX.

At a later step for creating a publication table 206, a table structure is created in the area local dedicated ADX, which is designed to store, for each element Y of the exclusive package, a publication status value, which defines whether the given element is already in the corresponding remote terminal TRX. Then, at the status of each element Y, an operation 207 is performed to assign the “non-published” status value.

The configuration module 105 then turns (step 208) to performing the same operations on the next remote terminal, and repeats the same from the aforementioned content list definition step 201 for that terminal. The loop is repeated for all the remote terminals TR1, TRN in the system.

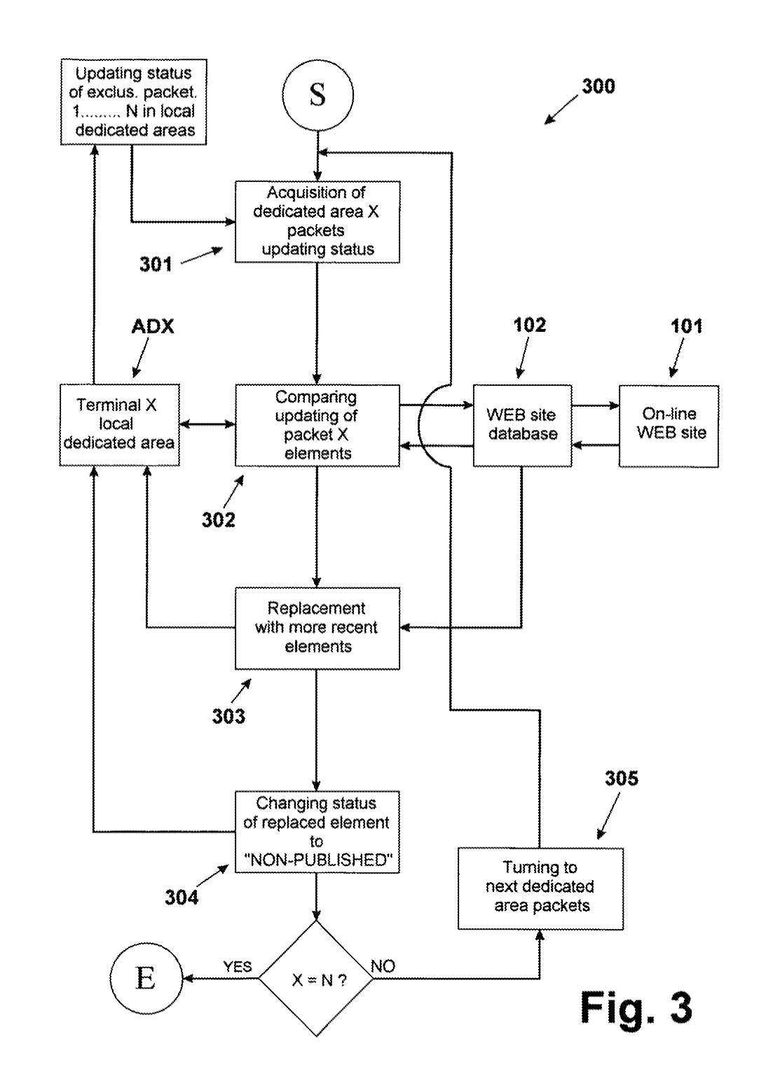

A local periodical updating operating loop 300 for the content exclusive packages (see diagram in FIG. 3) is also carried out by said configuration module 105 in server 100. Preferably, it is automatically activated at predefined time intervals and is designed to recognize, for each exclusive package present in the local memory dedicated areas AD1, ADN, the presence of elements Y older than corresponding elements in the database 102 of website 101, and to replace them with these latter elements.

It includes a first step 301, in which the updating status of each element Y of the local dedicated area ADX, is acquired and read, for example based on the date of the last modification made to the same element. Then a comparison is made between the update date of the element Y in the local dedicated area ADX and that of the same element in the web database 102.

For all elements Y whose update date is more recent in the database 101, the element present in the dedicated area ADX is replaced 303 with the one in the database 102.

For all elements Y which were replaced, a modification step 304 is finally performed on the publication status to “non-published”, in the corresponding publication table. The configuration module 105 then turns (step 305) to scanning the elements related to the next exclusive package, and performs again the operations from the status acquisition step 301.

A further operating loop of the present method, implemented on the local server 100, not shown as simple and easy to understand, includes periodical running, on the same local server 100, a sequence of clearing steps of the content exclusive packages residing in their respective local dedicated areas AD1, . . . ADN, activated by an operator acting in the same local server.

The local clearing loop includes, for each said exclusive package, an identification step of the elements of said contents which are considered to be obsolete, and are not, therefore, to be made available to navigation any more, and a deletion step for removing the same from the exclusive package locally resident.

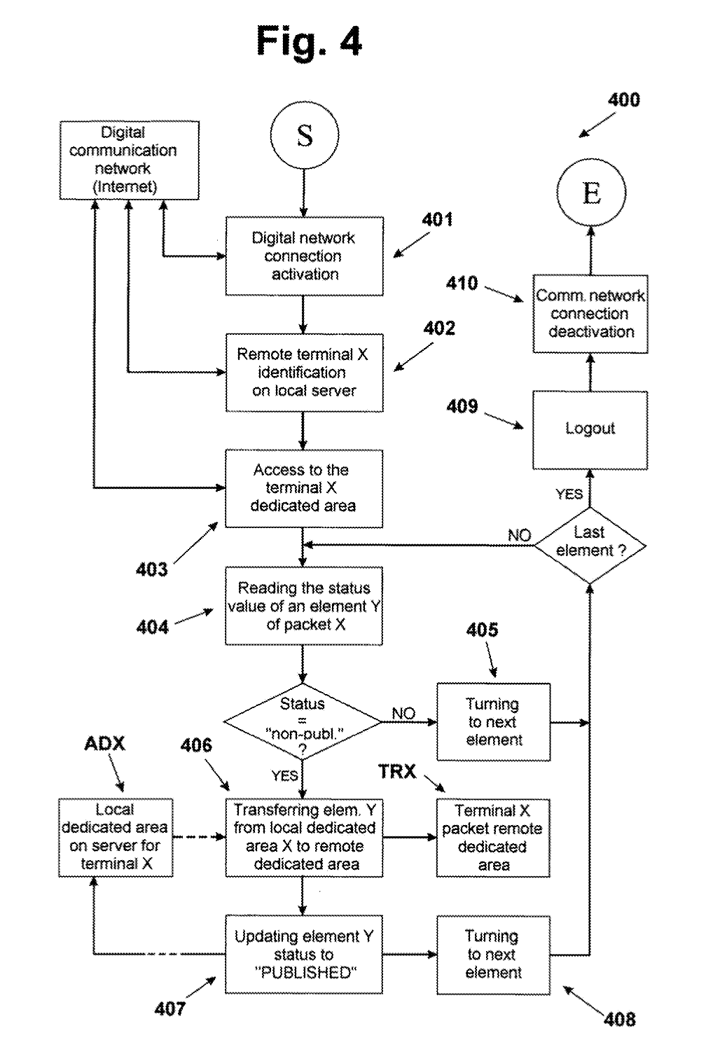

The method according to the invention also provides for periodical execution of a remote updating loop 400 on each remote terminal TRX, by the above described remote updating module 54 (see FIG. 4). This remote loop 400 is preferably activated when the remote terminal TRX is started, and when its functional structures are loaded, and includes either connecting the terminal itself to the digital communication network, in particular, via a broadband Internet connection, or making it capable of being connected via activation of a network connection.

At this point the remote updating loop 400 performs a step 401 in which a connection to said communication network is activated, and a step 402 in which the remote terminal TRX on the local server 100 is identified. This last operation can be carried out using standard methods and protocols for access and identification on a TCP/IP network, for example, it may require the provision of an access code and password, ensuring only the vision of the local dedicated area ADX assigned to that particular remote terminal TRX.

Subsequently a step 403, for accessing the said local dedicated area ADX, and a step 404, for reading the status value of an element Y of the content exclusive package of that remote terminal TRX in the table publication of the same, are performed.

If the status value is equivalent to “published”, the loop turns (step 405) to evaluating the next element, and makes no further action.

If the value is equivalent to “non-published”, the loop continues with a step 406 in which the local dedicated area ADX of element Y is transferred to the corresponding position of the remote dedicated area of the remote terminal TRX.

The status value of element Y is then updated (step 407) to “published” in the publication table, and the remote updating module 54 turns to evaluating the next element Y (408).

Once evaluated, and possibly replaced, the last element of the package, the loop ends with a logout step (409) and a deactivation step (410) for the connection to the communication network.

In the event that the connection of the remote terminal TRX to the communication network is permanent, the activation and deactivation steps 410, 401 of the connection can of course be omitted.

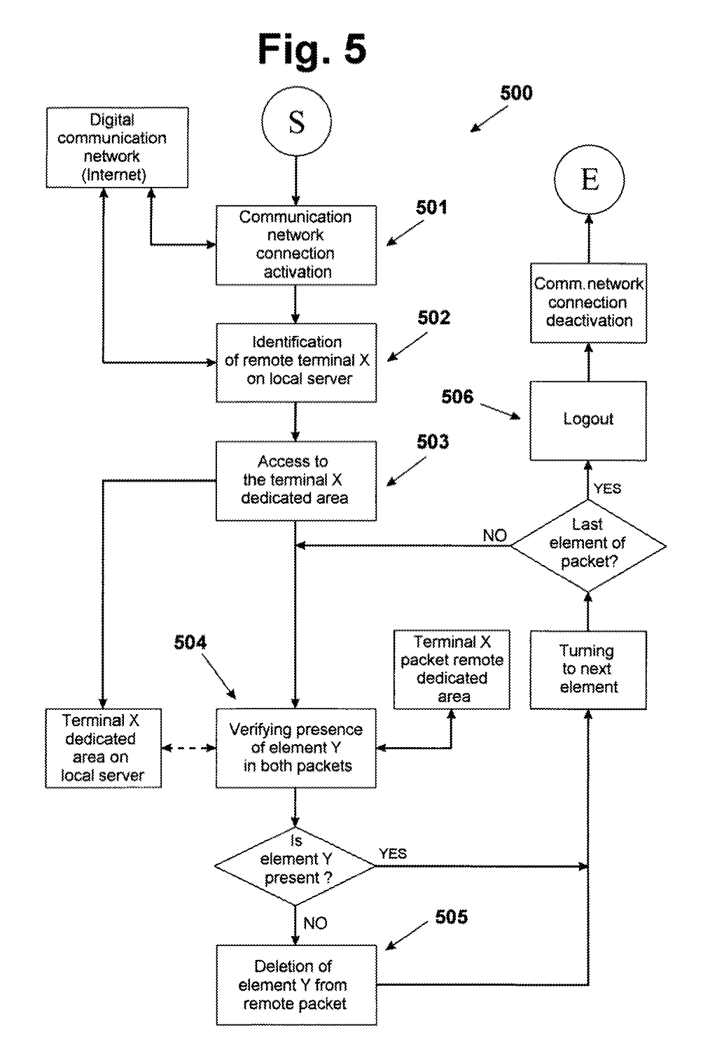

In each remote terminal TRX a remote clearing loop 500 is also periodically carried out (see FIG. 5), which is designed to remove from the exclusive package of that terminal Y obsolete elements or those elements which you want to make no more accessible to users. This loop is performed by the above described remote clearing module 56 of each terminal, and provides first a step 501 in which the connection to the digital communication network 502 is activated and a step 502 in which the remote terminal TRX on the local server 100 is identified, as previously described. Then a step 503 for accessing the local dedicated area ADX for that terminal on the same local server 100, and a stage 504 for verifying the presence of an element Y of the remote exclusive package in the corresponding position of said local dedicated area ADX, follow. In the event that such element Y has been previously removed during a local clearing loop described above, and the same element Y is no longer present in the local dedicated area ADX, then it is removed (step 505), and is not any further available for browsing. The clearing loop 500 continues with turning to the next element (step 506) and with the performance of a new verifying step 504.

Once the last element Y of the exclusive package has been verified, the final logout step (506) and the network connection deactivation step (507) are carried out.

Also in this case, the network connection activation and deactivation steps 501 and 507 can be omitted if the connection to the communication network is permanent.

Finally, for each remote terminal TRX a continuous operating loop is executed at each start up, which is adapted to make the related content exclusive package available to a plurality of users accessing that given information point. As already mentioned, a fully interactive operability is achieved, with an user interface organization in accordance with the criteria and functions of a website, which accesses only off-line contents consisting of the above content exclusive package.

Both the navigation modes offered by the remote operating loop, and the software structures needed for its implementation, are extremely variable, and anyway they are feasible by those skilled in the art on the basis of programming and design well-known tools, and of their own professional experience. They are not, therefore, to be considered peculiar to the implementation of the invention, and will not be described in further detail.

However, the organization of the information point of this system remains particularly original and advantageous, for the purposes of the invention, with a high degree of interactivity and ease of use of the emulation data of an off-line website in the remote terminals, and also the fact that this website is a subset and a partial image of the corresponding on-line website.

Another important advantage that present invention allows to achieve is to provide means for the creation, distribution and selective publication of data on remote terminals, which enables a highly customized use of the content of each terminal for each user of the same.

A further advantage of the invention is to provide a tool for the creation, distribution and selective publication of data on remote terminals, which tool, since updating of the content to be published on each remote terminal is initiated by the remote terminal itself, simplifies functions and efforts of the operator assigned to handling the system, and thus reduces the cost of management.

Yet another advantage of the invention is to provide a tool for the creation, distribution and selective publication of data on remote terminals, which can handle the distribution of high quality multimedia contents, minimizing the use of resources on the data transmission lines, since the remote terminals do not need to have a permanent connection to a broadband digital communication network, while maintaining a substantially constant updating of the remote contents.

Structuring the access mode to the exclusive packages as an off-line website organized as a partial image of the on-line website, advantageously allows users already accustomed to access it, to further streamline the review of the contents of the information point, and however, it facilitates the use by anyone with some on-line browsing skill.

It is understood that the above has been described by way of mere example and is not limiting. Therefore, possible modifications and variations are considered within the protection scope of the invention granted to this technical solution, as described above and claimed below.

1. A method for the creation, selection, distribution and selective publication of data on remote terminals adapted to operate ad information points, with each of said remote terminals TR1, . . . TRX, . . . TRN including at least a processing unit (50), having a remote memory unit (53) and a data transmission-receipt unit (55) for transmitting-receiving data on-from a digital communication network and further including at least an input unit (52,) connected to said processing unit (50) and designed to allow interaction by a user of said terminal (TRX), and a multimedia content display unit (51), connected to said processing unit (50) and adapted to display said contents ad processed by the same, said contents being originated for each said information point from a content database (102) residing on a local server (100) connected to said digital communication network, said method being characterized by including cyclic and asynchronous execution of different sequences of operational steps, respectively corresponding to:
a local creating loop (200), performed by a configuration module (105) operating on said local server (100), for creating content exclusive packages for each of said remote terminals (TRX), making up as many subsets of said database (102), and storing said packages in corresponding dedicated areas (ADX) of a temporary memory resident on the local server (100), said creating loop being periodically activated by an operator acting in said local server (100);
a local periodical updating loop (300) for updating said content packages, carried out by said configuration module (105) and automatically activated at predefined time intervals, designed to recognize, for each said package, older items with respect to corresponding elements residing in said database (102), and to replace them with these latter;
for each said remote terminal (TRX), a remote updating loop (400) for periodically updating a remote package of said contents, said remote package being formed by an image of the corresponding said exclusive package resident on the local server (100), said remote updating loop (400) including an access to said temporary memory dedicated area (ADX) resident on the local server (100) via said digital communication network, and at least one retrieval operation of the elements of its content package which are updated by the aforementioned local updating loop (300);
for each said remote terminal (TRX), a continuous operating loop, adapted to make said contents available to a plurality of users, on the display unit (51), according to modes defined by commands received by the same users via said input unit (52).

2. The method of claim 1, characterized in that said local creating loop (200) for creating packages includes the following steps:
definition (201) of a list of contents of each said remote terminal (TRX) by said configuration module (105);
for each said remote terminal, copying (205) said contents from a memory area of said database (102) to said temporary memory dedicated area (ADX) of said remote terminal (TRX) and consequent creation of a dedicated content package for the same;
definition (206) of the publication status of each element of said list of contents for each of said dedicated memory areas (ADX) and assignment (207) of “non-published” value to said status in a corresponding publication table, resident in said temporary memory area (ADX).

3. The method of claim 1, characterized in that said local updating loop (300) for updating packages includes, for each content package resident in the dedicated memory area (ADX) of a single remote terminal, the steps of:
reading (301) the updating status of each element of said package;
comparing (302) the updating status of each element with an updating status of a corresponding element in the aforementioned database (102);
copying (303) this last element in the aforementioned dedicated memory area (ADX), if the same results to be more up to date than the corresponding element present in said dedicated memory area (ADX);
assigning (304) a “non-published” value to said publication status of said element in said publication table.

4. The method of claim 1, characterized in that said content packages in each said remote terminal (TRX) is organized according to criteria of a website, and that said operating loop includes display functions via the aforementioned display unit (51), and interaction functions with the user via said input unit (52), adapted to emulate an off-line navigation on said website.

5. The method of claim 1, characterized in that said remote updating loop (400) for periodically updating the package of contents resident on each remote terminal (TRX), comprises the step of:
accessing (401) said digital communication network:
identifying (402) of said single remote terminal (TRX) on said local server (100) via said communication network;
reading (404) the state values of each element of said exclusive content package in the above mentioned publication table resident in the temporary memory dedicated area (ADX) related to the particular remote terminal (TRX);
transferring (406) each element of that content package for which the status value in said publication table corresponds to “non-published”, from said dedicated area (TRX) to a corresponding memory area (53) of said remote terminal, intended to accommodate a corresponding remote content package;
for each said transferred element, updating (407) the related status value in said publication table to “published” value.

6. The method of claim 5, characterized in that said accessing step (401) to the digital communication network also includes a preliminary activation step of said network connection, and a final deactivation step (410) of said connection.

7. The method of claim 5, characterized in that said remote updating loop (400) is performed when the remote terminal (TRX) is turned on.

8. The method of claim 5, characterized in that said remote updating loop (400) is performed at predetermined time intervals.

9. The method of claim 1, characterized by further including periodical execution, on said local server (100), of a further local clearing loop for clearing said content exclusive packages residing in said respective dedicated areas AD1, ADX, . . . AND, activated by an operator acting in said local server (100) and including, for each said exclusive package, identifying steps of at least one obsolete element of said contents and a removing step of the same from said exclusive package.

10. The method of claim 1, characterized in that a periodical execution of a further remote clearing loop (500) is also performed on each said remote terminal (TRX), which loop includes the steps of:
accessing (501) said digital communication network:
identifying (502) said single remote terminal (TRX) on said local server (100) via said network;
verifying (504) the presence of each element of said remote content exclusive package resident on the remote terminal (TRX) in the related local content package resident on said local server (100);
removing (505), from said remote package, the elements still present in the same and no longer present in the local package.

11. The method of claim 10, characterized in that said remote clearing loop (500) is performed when said remote terminal is turned on.

12. The method of claim 1, characterized in that said local server (100) is a web server, designed to provide structure and contents for an on-line website, in that said database (102) is made up of the overall contents of said website, and in that said content packages include subsets of said overall contents, organized as many off-line websites having structure and access methods identical or similar to those of said on-line website.

13. The method of claim 2, characterized in that said local updating loop (300) for updating packages includes, for each content package resident in the dedicated memory area (ADX) of a single remote terminal, the steps of:
reading (301) the updating status of each element of said package;
comparing (302) the updating status of each element with an updating status of a corresponding element in the aforementioned database (102);
copying (303) this last element in the aforementioned dedicated memory area (ADX), if the same results to be more up to date than the corresponding element present in said dedicated memory area (ADX);
assigning (304) a “non-published” value to said publication status of said element in said publication table.

14. The method of claim 9, characterized in that a periodical execution of a further remote clearing loop (500) is also performed on each said remote terminal (TRX), which loop includes the steps of:
accessing (501) said digital communication network:
identifying (502) said single remote terminal (TRX) on said local server (100) via said network;
verifying (504) the presence of each element of said remote content exclusive package resident on the remote terminal (TRX) in the related local content package resident on said local server (100);
removing (505), from said remote package, the elements still present in the same and no longer present in the local package.

15. The method of claim 14, characterized in that said remote clearing loop (500) is performed when said remote terminal is turned on.
